(19) United States
(12) Patent Application Publication
(10) Pub. No.: US 2012/0289206 A1
(43) Pub. Date: Nov. 15, 2012

(54) SYSTEM AND METHOD FOR MANAGING SCHEDULES IN MOBILE DEVICE

(75) Inventor: Min Sik SHIM, Yongin-si (KR)

(73) Assignee: Samsung Electronics Co. Ltd., Suwon-si (KR)

(21) Appl. No.: 13/437,116

(22) Filed: Apr. 2, 2012

(30) Foreign Application Priority Data
May 13, 2011 (KR) 10-2011-0044937

(51) Int. Cl. H04W 4/16

(52) U.S. Cl. 455/414.1

(57) ABSTRACT

A system and a method that automatically manages schedules in a mobile device via the schedule text message are provided. The method includes receiving a schedule text message, extracting at least one schedule from the received text message, and adding at least one extracted schedule to a schedule management application program. The system and method allows the users to easily manage schedules via Short Messaging Service (SMS). Mobile device users can write a text message without missing schedule information and send the text message to the other mobile device users. Because the system and method records schedule information, included in a text message that a mobile device user received from another device user, in the schedule in the user's mobile device, the mobile device user does not need to memorize and input the schedule information.

### PRIORITY

This application claims the benefit under 35 U.S.C. §119(a) of a Korean patent application filed on May 13, 2011 in the Korean Intellectual Property Office and assigned Serial No. 10-2011-0044937, the entire disclosure of which is hereby incorporated by reference.

### BACKGROUND OF THE INVENTION

1. Field of the Invention:

The present invention relates to a system and method that manages schedules in a mobile device. More particularly, the present invention relates to a system and method for managing schedules in a mobile device via received text messages.

2. Description of the Related Art:

In general, mobile devices support Short Messaging Service (SMS). SMS is generally used when users are in a situation in which the respective users cannot make/receive a call, or in which the respective users do not need or prefer not to make/receive a call. Mobile device users may receive a call from an event host, informing the respective users of an event. The users may also receive a text message regarding the event. Text messages are generally used for personal events or business. Business enterprises may send text messages to customers to make an appointment, by inform the customers of a place and time associated with the appointment. When customers purchase goods, the business enterprises from whom the customers purchased the goods may send the customers description of the goods purchase via SMS. As such, the use of SMS in mobile devices has increased at the same rate as calling services. For example, instead of making a direct call, mobile device users may use SMS in order to make an appointment.

Most mobile devices include a schedule management application as a default option, so as to enable mobile device users to manage personal schedules in their respective mobile devices and to view their respective personal calendars, instead of having to use pocket notebooks.

When the mobile device user intends to record schedule information, which is included in a text message (e.g., via SMS), in the mobile device user's respective schedule provided by a schedule management application in the mobile device, the mobile device user must memorize the text message content, execute the schedule management application, and input appointment information (e.g., including place, date, subject, and the like).

As such, related schedule management systems are disadvantageous in that related schedule management systems still require mobile device users to memorize schedule information in the text messages and to input, one-by-one, the memorized information to the schedule in the mobile devices provided by the schedule management applications.

Therefore, a need exists for a system and method for managing schedules in a mobile device.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below. Accordingly, an aspect of the present invention is to provide a system and method that can automatically input schedule information included in a text message into a schedule management application, thereby enhancing convenience for a user.

In accordance with an exemplary embodiment of the present invention, a method for managing schedules in a mobile device is provided. The method includes receiving a schedule text message, extracting at least one schedule from the received text message, and adding at least one extracted schedule to a schedule management application program.

In accordance with another exemplary embodiment of the present invention, a method for automatically managing schedules via a Short Messaging Service (SMS) is provided. The method includes operating in a text message transmission mode and determining whether a command for writing a schedule text message is input, displaying, when a command for writing a schedule text message is input, a schedule text message transmission user interface including at least one schedule item field, receiving at least one schedule item that a user inputs via the corresponding at least one schedule item fields, and creating a schedule text message including the at least one schedule items.

In accordance with another exemplary embodiment of the present invention, a mobile device is provided. The mobile device includes an RF communication unit for receiving a schedule text message, a controller for extracting at least one schedule from the received text message, a display unit for displaying a schedule text message user interface on which at least one schedule is shown, and a storage unit for storing the at least one extracted schedule.

In accordance with another exemplary embodiment of the present invention, a method for managing schedules in a mobile device is provided. The method includes receiving a text message, determining whether the text message is a schedule text message, extracting scheduling information from the received text message, if the received text message is determined to be a schedule text message, and adding the extracted scheduling information to a schedule management application program.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will become more apparent from the following description taken in conjunction with the accompanying drawings, in which:

FIG. 1 illustrates a schematic block diagram showing a mobile device according to an exemplary embodiment of the present invention;

FIG. 2 illustrates a flow-chart that describes an automatic schedule management method for receiving a schedule text message and adding information associated with the schedule text message in a schedule management application, according to an exemplary embodiment of the present invention;

FIG. 3 illustrates a user interface shown on a display unit when a mobile device receives a schedule text message, according to an exemplary embodiment of the present invention;

FIG. 4 illustrates a flowchart that describes an automatic schedule management method for transmitting a schedule text message, according to an exemplary embodiment of the present invention; and

FIG. 5 illustrates a user interface shown on a display unit when a mobile device sends a schedule text message according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term ‘schedule text message(s)’ refers to a text message(s) that includes schedule information. According to exemplary embodiment of the present invention, the schedule information may be automatically input/added to a schedule management application program. In exemplary embodiments of the present invention, examples of the schedule text message may be Short Message Service (SMS) messages or Multimedia Message Service (MMS) messages. A schedule text message may include various fields such as, for example, a subject, a body, a date, a reminder, and/or the like.

The term ‘schedule text message reception user interface’ refers to a screen displayed on a display unit of a mobile device when the mobile device receives a schedule text message. The schedule text message reception user interface may shows various fields (e.g., the subject, the body, the date, the reminder, and the like). As an example, the fields may be arranged in order of the subject, the body, the date, and the reminder. The field corresponding to the body may be the largest. For example, the body field may have the largest display area relative to the other field displayed by the display unit.

The term ‘schedule text message transmission user interface’ refers to a screen displayed on the display unit of the mobile device that allows a user to input schedule information in the text message to be transmitted. The schedule text message transmission user interface may show various fields (e.g., a subject, a body, a date, a reminder, and the like).

The term ‘schedule management application program’ refers to an application program installed on the mobile device that provides various schedule management functions. For example, the schedule management application program may include functionality such as, for example, a date checking function, a personal schedule managing function, an alarm setting function, and the like.

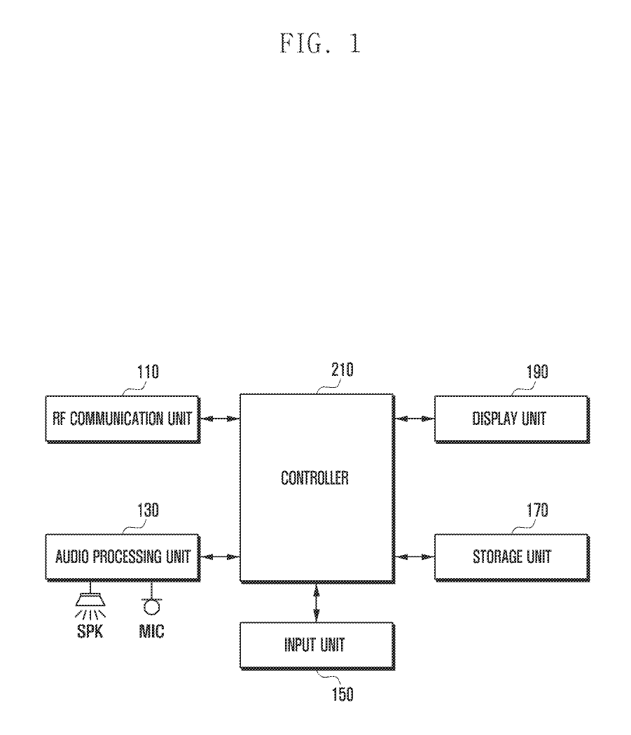

FIG. 1 illustrates a schematic block diagram showing a mobile device according to an exemplary embodiment of the present invention.

Referring to FIG. 1, a mobile device includes an RF communication unit 110, an audio processing unit 130, an input unit 150, a storage unit 170, a display unit 190, and a controller 210.

The RF communication unit 110 wirelessly transmits/receives data to/from other communication systems. The RF communication unit 110 includes an RF transmitter for up-converting the frequency of signals to be transmitted and for amplifying the signals. The RF communication unit 110 may also include an RF receiver for low-noise amplifying received RF signals and for down-converting the frequency of the received RF signals. The RF communication unit 110 receives data via an RF channel and outputs the received data to the controller 210. The RF communication unit 110 also transmits data, output from the controller 210, via the RF channel. According to an exemplary embodiment of the present invention, the RF communication unit 110 receives a schedule text message via a mobile communication network and outputs the schedule text message to the controller 210. In addition, according to exemplary embodiments of the present invention, the RF communication unit 110 also transmits a schedule text message from the controller 210 to other devices via a network. For example, the RF communication unit 110 may transmit a schedule text message to other mobile device via mobile communication network.

The audio processing unit 130 plays back audio signals output from the controller 210. The audio processing unit 130 processes audio signals received via a Microphone (MIC), such as voice signals, and outputs such audio signals to the controller 210. The audio processing unit 130 processes voice/audio data under the control of the controller 210, and outputs audible audio sounds via a Speaker (SPK). The audio processing unit 130 also converts analog audio signals received via the MIC, such as voice signals, into digital audio signals.

The input unit 150 includes a number of alphanumeric keys and function keys that allow the user to input numbers, letters, commands, and/or the like, and to set a variety of functions. The alphanumeric keys may be implemented with a 3×4 keypad, a QWERTY keypad, or the like. The function keys may include direction keys, side keys, shortcut keys, and/or the like. In an exemplary embodiment of the present invention, the input unit 150 receives a schedule text message writing command that the user inputs, and/or a menu selection command such as a schedule text message writing menu or a schedule adding menu. According to exemplary embodiments of the present invention, the input unit 150 may be integrated and/or installed in the display unit 190. For example, the input unit 150 may be configured as a touch screen. The input unit 150 may also be some combination of a touch screen and keys disposed on other areas of the mobile device.

The storage unit 170 stores application programs for executing functions according to exemplary embodiments of the present invention. The storage unit 170 may also store content downloaded from the network, user's created data, and/or the like. The storage unit 170 may include a program storage area and a data storage area. The program storage area stores an Operating System (OS) for booting the mobile device, a text message application program, and/or the like. The data storage area stores data created when the mobile device is used For example, the data storage area stores schedule information input to be recorded in a schedule management application program. The storage unit 170 also serves as a buffer for storing user data created when a text message application program is executed.

The display unit 190 displays output from the mobile device. For example, the display unit 190 may display menus, user's input data, function setting information, information provided to the user, and the like. The display unit 190 may be implemented with a Liquid Crystal Display (LCD), an Organic Light Emitting Diode (OLED), an Active Matrix Organic Light Emitting Diodes (AMOLED), or the like. The display unit 190 may be implemented with a touch screen with a touch panel. In that case, the display unit 190 may also serve as an input device. In an exemplary embodiment of the present invention, the display unit 190 displays a ‘schedule text message Transmission User Interface (TUI)’ and a ‘schedule text message Reception User Interface (RUI).’

The controller 210 controls the operation of the mobile device and controls the signals flowing between the components in the mobile device. For example, the controller 210 controls the RF communication unit 110 to receive a text message including schedule information. The controller 210 determines whether the received text message is a schedule text message including schedule information or a general text message. To this end, the controller 210 may extract an identification code from the header in the received text message. The header in the text message may include an identification as to a type of text message (e.g., an SMS message, an MMS message, a schedule text message, and/or the like). The controller 210 identifies the received schedule text message and then controls the display unit 190 to display the received schedule text message via the schedule text message Reception User Interface. The controller 210 refers to the headers of fields (e.g., the subject, the body, the date, the reminder, and the like) included in the schedule text message, and classifies the fields. The controller 210 forms a schedule text message Reception User Interface according to the classified fields, and displays the schedule text message Reception User Interface on the display unit 190.

The controller 210 receives, via the input unit 150, a user's input command for adding to a schedule management application program schedule information that is included in a schedule text message., The controller 210 then executes the program. The controller 210 controls the display unit 190 to display a user interface for showing options that provide a user an opportunity to decide whether to directly add the schedule information in the schedule management application program, or to add the schedule information in the schedule management application program after editing. If the controller 210 determines that the user selects an option associated with directly adding the schedule information in the schedule management application program via the input unit 150, then the controller 210 adds schedule fields (e.g., items), included in the schedule text message, in the schedule management application program. Conversely, if the controller 210 determines that the user selects the option associated with adding the schedule information in the schedule management application program after editing, then the controller 210 controls the display unit 190 to display all schedule items included in the received schedule text message. After that, when the controller 210 receives an edit command that the user inputs to the input unit 150, the controller 210 edits the items and then adds such items to the schedule management application program.

The controller 210 may also receive a command for executing a text message transmission mode that the user input via the input unit 150. If the controller 210 receives such a command, then the controller 210 controls the display unit 190 to display a command text message Transmission User Interface. The command text message Transmission User Interface provides a key for executing a schedule text message writing function. When the controller 210 receives a command for writing a schedule text message that the user inputs via the input unit 150, the controller 210 calls a schedule composer and controls the display unit 190 to display a schedule text message Transmission User Interface. When the controller 210 receives schedule information items that the user inputs via the input unit 150 and a transmission command, the controller 210 allocates an identification code, indicating a schedule text message, to the header in the text message. Alternatively, the controller 210 may encode the headers of the schedule items (e.g., the subject, the body, the date, the reminder, and the like) included in the schedule information, if the schedule items are input to the corresponding fields of the schedule text message Transmission User Interface. In other words, the controller 210 may encode the headers of the schedule fields having corresponding entries. The controller 210 controls to transmit, to an external mobile device, via the RF communication unit 110, a schedule text message that includes an identification code indicating a type of text message and the headers of the items.

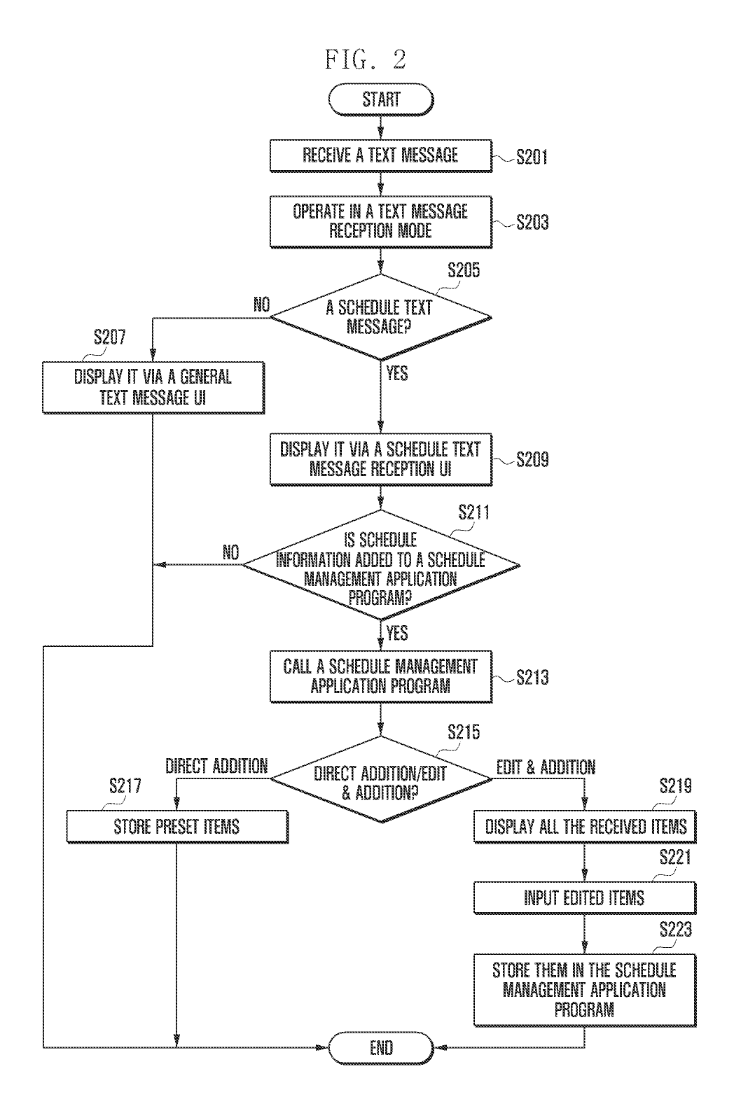

FIG. 2 illustrates a flow-chart that describes an automatic schedule management method for receiving a schedule text message and adding information associated with the schedule text message in a schedule management application, according to an exemplary embodiment of the present invention.

Referring to FIG. 2, the RF communication unit 110 of the mobile device receives a text message via the RF channel at step S201. When the controller 210 receives the text message from the RF communication unit 110, the controller 210 controls the display unit 190 to display a reminder (e.g., an emoticon, and/or the like) for informing the user of the reception of the text message.

The controller 210 receives a command for operating a text message reception mode that the user input via the input unit 150 at step S203.

The controller 210 determines whether the received text message is a schedule text message at step S205. For example, the controller 210 detects an identification code in the header of the received text message. If the controller 210 determines that the header includes an identification code representing a schedule text message, the controller 210 determines that the received text message is a schedule text message.

If the controller 210 concludes that the received text message is a general text message at step S205, then the controller 210 controls the display unit 190 to display the content of the received text message via a general text message user interface at step S207.

Conversely, if the controller 210 determines that the received text message is a schedule text message at step S205, the controller 210 controls the display unit 190 to display the content of the received text message including schedule information, by the schedule items, via the schedule text message user interface at step S209. The controller 210 may refer to the header(s) of the respective schedule items in the schedule information of the schedule text message, forms a user interface, classifies the schedule information according to the items (i.e., corresponding entries in the fields) for the user interface, and displays the items on the display unit 190. In an exemplary embodiment of the present invention, the header for a schedule text message is encoded to represent the respective items of the schedule information, and is included in the body of a text message. The header may be encoded via ASCII, or the like.

The headers of the schedule text message are encoded to represent the feature of the items of schedule information, included in the body of a text message, and represented via the ‘#’ and special characters according to the items. For example, the representations of the various fields and entries associated there to may be as follows: Subject: #! (0×23 0×20), Body: #$ (0×23 0×24), Date: #% (0×23 0×25), and Reminder: #! (0×23 0×26). In such an example, the schedule text message with the headers are encoded in an order of (Subject Header) Subject|(Body Header) Body|(Date Header) Date|(Reminder Header) Reminder (#).

The controller 210 determines whether the user inputs, to the input unit 150, a command for adding schedule information, included in the schedule text message, in a schedule management application program at step S211. The schedule text message user interface provides an interface for the user to select a function for adding schedule information in a schedule management application program. The controller 210 detects whether the user selects the interface via the input unit 150. When the controller 210 determines that the user inputs a command for adding schedule information, included in the schedule text message, in a schedule management application program at step S211, the controller 210 calls the program from the storage unit 170 at step S213. Thereafter, the controller 210 controls the display unit 190 to display an interface for the user to select a schedule direct adding function (e.g., a function associated with directly adding the schedule information in the schedule management application program) or a schedule editing and adding function (e.g., a function associated with adding the schedule information in the schedule management application program after editing). The controller 210 determines whether the user inputs, via the input unit 150, a command for selecting a schedule direct adding function or a schedule editing and adding function at step S215.

When the controller 210 determines that the user inputs, via the input unit 150, a command for selecting a schedule direct adding function at step S215, the controller 210 directly adds the schedule information in the schedule management application program at step S217. That is, the controller 210 directly adds the preset items of the schedule information, included in the received schedule text message, to the schedule management application program.

Conversely, when the controller 210 determines that the user inputs, via the input unit 150, a command for selecting a schedule editing and adding function at step S215, the controller 210 controls the display unit 190 to display all the received items at step S219. After that, the controller 210 receives edited items via the input unit 150 at step S221. That is, the controller 210 edits the schedule information according to the user's input keys. When the controller 210 receives an edit completion command that the user inputs, the controller 210 adds the edited schedule information items in the schedule management application program at step S223.

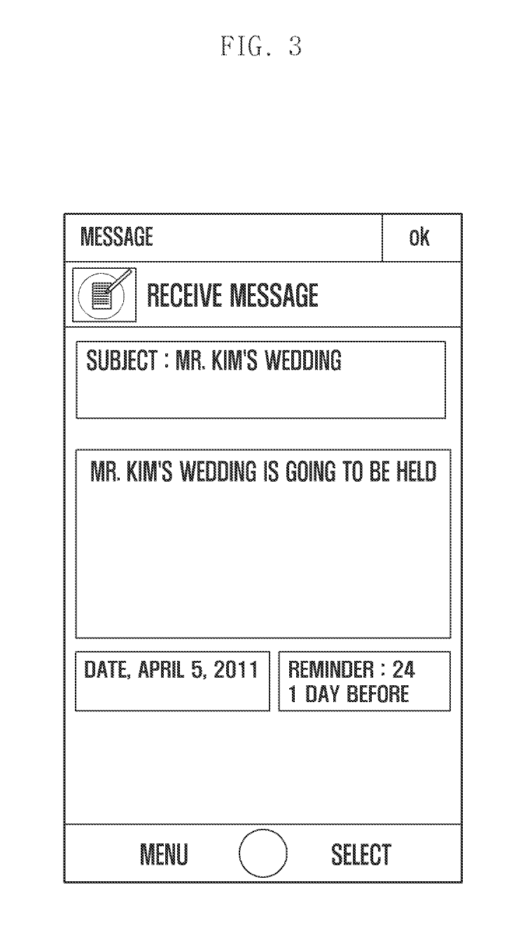

FIG. 3 illustrates a user interface shown on a display unit when a mobile device receives a schedule text message according to an exemplary embodiment of the present invention.

Referring to FIG. 3, the schedule text message Reception User Interface includes various fields (e.g., a subject, a body, a date, a reminder and the like). Referring to FIG. 3, the Reception User Interface is shown on the display unit 190. As an example, the controller 210 controls the display so as to arrange such that the subject field is displayed at the top of the display area that is displayed by the display unit 190, the body field displayed below the subject field, and the date and reminder fields are displayed below the body field. According to an exemplary embodiment of the present invention, the body field may be the largest field with respect to display area in the user interface.

Referring to FIG. 3, the fields show contents of the respective items included in the received schedule text message. The controller 210 controls the display unit 190 to display schedule information corresponding to the items fields according to the headers identified from the received schedule text message.

For example, as shown in FIG. 3, the user interface shows the subject field showing ‘Mr. Kim's wedding,’ the body field showing ‘Mr. Kim's wedding is going to be held,’ the date field showing ‘Apr. 5, 2011,’ and the reminder field showing ‘24 hours.’ The controller 210 detects the headers of the items and inputs ‘Mr. Kim's wedding’ in the subject field, ‘Mr. Kim's wedding is going to be held’ in the body field, ‘Apr. 5, 2011’ in the date field, and ‘24 hours’ in the reminder field, respectively. As an example, the function of the reminder field showing ‘24 hours’ will remind the user of the schedule event before 24 hours.

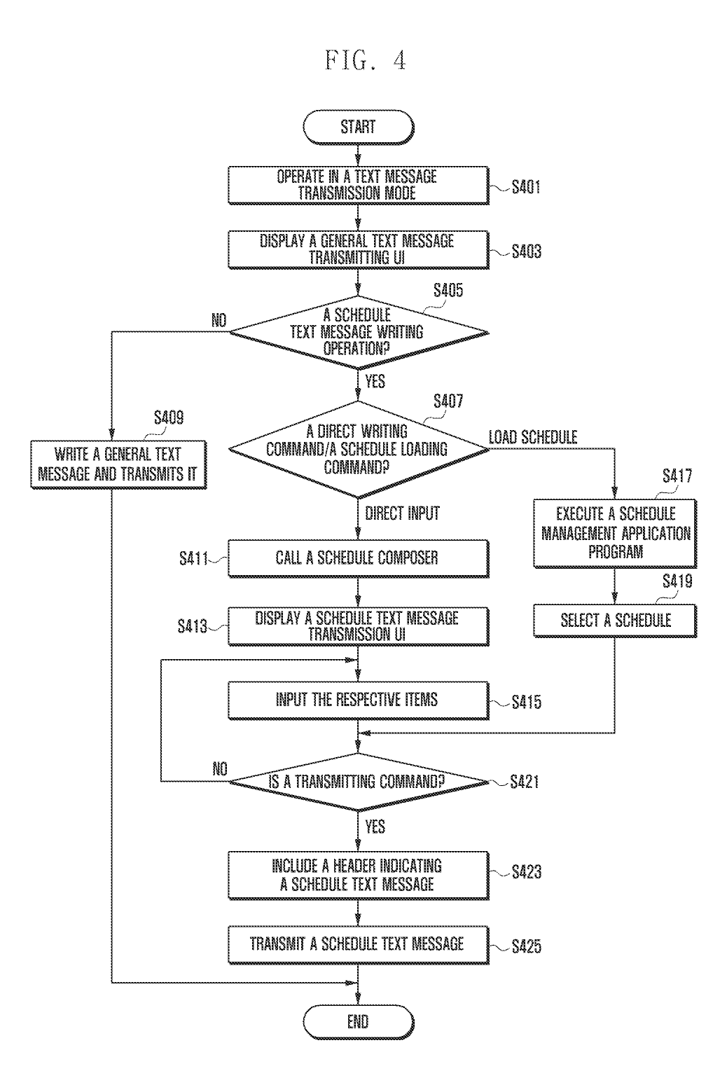

FIG. 4 illustrates a flowchart that describes an automatic schedule management method for transmitting a schedule text message, according to an exemplary embodiment of the present invention.

Referring to FIG. 4, the controller 210 receives a command for entering a text message transmission mode that the user inputs via the input unit 150 at step S401. The controller 210 controls the display unit 190 to display a general text message Transmission User Interface at step S403. In an exemplary embodiment of the present invention, the general text message Transmission User Interface provides an interface that allows the user to select a schedule text message writing function.

The controller 210 determines whether the user inputs, via the input unit 150, a command for writing a schedule text message at step S405. When the controller 210 determines that the user does not input a command for writing a schedule text message at step S405, the controller 210 creates a general text message as the user inputs text contents via the input unit 150, and controls the RF communication unit 110 to transmit the created general text message to an external device (e.g., a mobile device) via the RF channel at step S409.

Conversely, when the controller 210 determines that the user inputs a command for writing a schedule text message at step S405, the controller 210 determines whether the user's input command corresponds to a direct writing command or a schedule loading command at step S407. That is, when the controller 210 receives a command for writing a schedule text message, the controller 210 controls the display unit 190 to display an interface for selecting a direct writing function or a schedule loading function. The controller 210 detects whether the user inputs a direct writing command or a schedule loading command to the interface.

When the controller 210 determines that the user inputs a direct writing command at step S407, the controller 210 calls a schedule composer at step S411, and controls the display unit 190 to display a schedule text message Transmission User Interface at step S413.

The controller 210 receives the items of schedule information that the user inputs via the input unit 150 at step S415. The items may include, for example, the subject, the body, the date, the reminder, and/or the like. The controller 210 may receive all or part of the items via the corresponding fields in the interface.

Meanwhile, when the controller 210 determines that the user inputs a schedule loading command at step S407, the controller 210 executes a schedule management application program and controls the display unit 190 to display the schedule management application program at step S417. The controller 210 receives a command for selecting schedules shown in the schedule management application program that the user inputs at step S419. In that case, the user can select corresponding schedules that are input to the schedule management application program via the schedule information included in the schedule text message. Alternatively, the user may also select schedules that are stored in a format to use schedule text messages.

After performing steps S415 and S419, the controller 210 determines whether the user inputs a command for transmitting a schedule text message via the input unit 150 at step S421. When the controller 210 determines that the user does not input a command for transmitting a schedule text message at step S421, the controller 210 operates in a standby state until the user inputs the command.

When the controller 210 determines that the user inputs a command for transmitting a schedule text message at step S421, the controller 210 processes the schedule text message with schedule information to include the headers of the respective items at step S423, and controls the RF communication unit 110 to transmit the message via the RF channel at step S425.

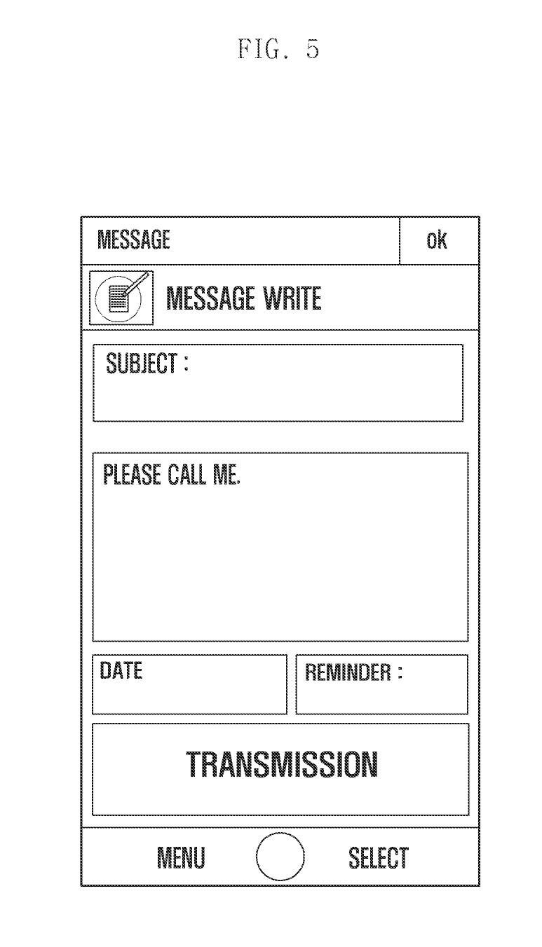

FIG. 5 illustrates a user interface shown on a display unit when a mobile device sends a schedule text message according to an exemplary embodiment of the present invention.

Referring to FIG. 5, the schedule text message Transmission User Interface includes fields corresponding to the subject, the body, the date, the reminder, and the like. Referring to FIG. 5, the Transmission User Interface is displayed on the display unit 190. As an example, the Transmission User Interface is configured such that the fields are arranged in order of the subject field, the body field, and the date and reminder fields. According to an exemplary embodiment of the present invention, the body field may be the largest field with respect to display area in the user interface.

As shown in FIG. 5, the fields show the respective items included in the schedule text message to be transmitted. The controller 210 creates a schedule text message including the headers with the items corresponding to the fields. Referring to FIG. 5, the user may input a subject representing a feature of the schedule message in the subject field, and input details in the body field. The user may also input a date in the date field, and a reminder time before the schedule in the reminder field (e.g., so as to provide a reminder at a given reminder time before the scheduled appointment or event time).

As described above, the schedule management system according to exemplary embodiments of the present invention allows the user to easily manage the schedule. The system allows a mobile device user to write a text message without missing schedule information and to send the text message to the other mobile device user. In addition, because the system records schedule information, included in a text message that a mobile device user received from other mobile device user, in the schedule in the user's mobile device, the mobile device user does not need to memorize and input such schedule information.

It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

Furthermore, the respective block diagrams may illustrate parts of modules, segments or codes including at least one or more executable instructions for performing specific logic function(s). Moreover, it should be noted that the functions of the blocks may be performed in different order in several modifications. For example, two successive blocks may be performed substantially at the same time, or may be performed in reverse order according to their functions.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for managing schedules in a mobile device, the method comprising:
receiving a schedule text message;
extracting at least one schedule from the received schedule text message; and
adding at least one extracted schedule to a schedule management application program.

2. The method of claim 1, wherein the adding of the at least one schedule is automatically added to a schedule management application upon receipt of the schedule text message and extraction of the at least one schedule.

3. The method of claim 1, wherein the reception of a schedule text message comprises:
receiving a schedule text message comprising at least one schedule item.

4. The method of claim 3, wherein the at least one schedule item corresponds to at least one of a subject, a body, a date, and a reminder.

5. The method of claim 3, wherein the extraction of the at least one schedule comprises:
identifying at least one header of the corresponding at least one schedule item included in the received schedule text message; and
extracting the at least one schedule item corresponding to the identified at least one header.

6. The method of claim 5, wherein the at least one header comprises:
ASCII codes.

7. The method of claim 5, wherein the extraction of the at least one schedule comprises:
displaying the at least one schedule item via a schedule text message user interface;
determining whether a command for adding the at least one schedule item in the schedule management application program is input;
calling, when a command for adding the at least one schedule item in the schedule management application program is input, a schedule management application program comprising input fields corresponding to the at least one schedule item;
adding the at least one schedule item extracted from the received schedule text message to the corresponding input fields; and
storing the corresponding input fields comprising the at least one schedule item added thereto.

8. The method of claim 7, wherein the storing of the corresponding input fields comprising the at least one schedule item added thereto comprises:
displaying at least one of a schedule direct adding option, and a schedule editing and adding option on the screen; and
adding the at least one extracted schedule item to the corresponding input fields, and storing the corresponding input fields comprising the at least one extracted schedule item added thereto, when a schedule direct adding option is selected.

9. The method of claim 7, wherein the storing of the corresponding input fields comprising that at least one schedule items added thereto further comprises:
displaying all of the at least one schedule item extracted from the received schedule text message, when a schedule editing and adding option is selected;
editing at least one of the displayed schedule item according to the user's inputs; and
adding the at least one edited schedule item to the corresponding input fields, and storing the corresponding input fields comprising the at least one edited schedule item added thereto.

10. A method for automatically managing schedules via a Short Messaging Service (SMS), the method comprising:
operating in a text message transmission mode and determining whether a command for writing a schedule text message is input;
displaying, when a command for writing a schedule text message is input, a schedule text message transmission user interface comprising at least one schedule item field;
receiving at least one schedule item that a user inputs via the corresponding at least one schedule item fields; and
creating a schedule text message comprising the at least one schedule item.

11. The method of claim 10, wherein the schedule text message comprises at least one schedule item.

12. The method of claim 11, wherein the at least one schedule item corresponds to at least one of a subject, a body, a date, and a reminder.

13. The method of claim 11, further comprising:
displaying, when a command for writing a schedule text message is input, an interface comprising an option for selecting a direct writing command, and a schedule calling command;
displaying, when a direct writing command is selected, a user interface for transmitting the schedule text message;
executing, when a schedule calling command is selected, a schedule management application program comprising fields corresponding to the at least one schedule item;
receiving a schedule selecting command that the user input; and
creating a schedule text message comprising the at least one schedule item that is input via the corresponding field.

14. The method of claim 11, wherein the creating of a schedule text message comprises:
receiving a transmitting command that the user input; and
inserting at least one headers corresponding to the at least one schedule item in the created schedule text message.

15. The method of claim 14, wherein the at least one header comprises:
ASCII codes.

16. A mobile device comprising:
an RF communication unit for receiving a schedule text message;
a controller for extracting at least one schedule from the received text message;
a display unit for displaying a schedule text message user interface on which at least one schedule is shown; and
a storage unit for storing the at least one extracted schedule.

17. The mobile device of claim 16, wherein the display unit displays a schedule text message user interface comprising at least one schedule item.

18. The mobile device of claim 17, wherein the at least one schedule item corresponds to at least one of a subject, a body, a date, and a reminder.

19. The mobile device of claim 17, wherein the controller identifies at least one header of the corresponding at least one schedule item included in the received schedule text message, and extracts the at least one schedule item corresponding to the identified at least one header.

20. The mobile device of claim 19, wherein the controller:
controls the display unit to display the at least one schedule item via a schedule text message user interface;
determines whether a command for adding the at least one schedule item in the schedule management application program is input;
calls, when a command for adding the at least one schedule item in the schedule management application program is input, a schedule management application program comprising input fields corresponding to the at least one schedule item;
adds the at least one schedule item extracted from the received schedule text message to the corresponding input fields; and
stores the corresponding input fields comprising the at least one schedule item in the storage unit.
